(19) United States
(12) Patent Application Publication
(10) Pub. No.: US 2024/0304175 A1
(43) Pub. Date: Sep. 12, 2024

(54) SPEECH MODIFICATION USING ACCENT EMBEDDINGS

(71) Applicant: SRI International, Menlo Park, CA (US)

(72) Inventors: Alexander Erdmann, Malvern, OH (US); Sarah Bakst, San Francisco, CA (US); Harry Bratt, Mountain View, CA (US); Dimitra Vergyri, Sunnyvale, CA (US); Horacio Franco, Menlo Park, CA (US)

(21) Appl. No.: 18/599,018

(22) Filed: Mar. 7, 2024

Related U.S. Application Data
(60) Provisional application No. 63/455,226, filed on Mar. 28, 2023.
(60) Provisional application No. 63/451,040, filed on Mar. 9, 2023.

(30) Foreign Application Priority Data
Mar. 16, 2023 (GR) 20230100219

(51) Int. Cl. G10L 13/047; G10L 15/16

(52) U.S. Cl. CPC G10L 13/047; G10L 15/16

(57) ABSTRACT

Techniques for a machine learning system configured to obtain a dataset of a plurality of sample speech clips; generate a plurality of sequence; initialize a plurality of speaker embeddings and a plurality of accent embeddings; update the plurality of speaker embeddings; update the plurality of accent embeddings; generate a plurality of augmented embeddings based on the plurality of sequence embeddings, the plurality of speaker embeddings, and the plurality of accent embeddings; and generate a plurality of synthetic speech clips based on the plurality of augmented embeddings. The machine learning system may further be configured to obtain an audio waveform; decompose the audio waveform into first magnitude spectral slices and an original phase; process the first magnitude spectral slices to map the first magnitude spectral slices to second magnitude spectral slices; and generate a modified audio waveform in part by combining the second magnitude spectral slices and the original phase.

### RELATED APPLICATIONS

This application claims the benefits of U.S. Patent Application No. 63/451,040, filed Mar. 9, 2023; Greece patent application Ser. No. 20/230,100219, filed Mar. 16, 2023; and U.S. Patent Application No. 63/455,226, filed Mar. 28, 2023; each of which is incorporated by reference herein in its entirety.

### TECHNICAL FIELD

This disclosure relates to machine learning systems and, more specifically, to machine learning systems that modify speech.

### BACKGROUND

Speech cloning systems may include machine learning models trained to create synthetic speech that closely resembles the speech of a particular individual. Speech cloning systems may be applied to perform accent modification or accent reduction to alter the accent of speech of a specific individual. Implementing speech cloning techniques in accent modification systems requires a substantial amount of training data consisting of recordings of the target individual's voice.

### SUMMARY

In general, the disclosure describes techniques for modifying speech using accent embeddings. In some examples, a computing system may train a text-to-speech (TTS) model to generate synthetic speech for use in training an accent conversion model to perform accent conversion of speech, in some cases in real time. The TTS model may be trained to disentangle accent from speech based on a training dataset of labeled speech clips that are each labeled with, e.g., the speech text, a speaker identity, and an accent represented in the speech clip. Many different speakers will have a common accent while having distinct speech characteristics, e.g., timbre, pitch, cadence, etc. By training with training data of labeled speech clips from many different speakers having multiple different accents, the TTS model is trained to disentangle the accents from the speech characteristics of the speakers' speech. The trained TTS model can therefore synthesize speech for a speaker in multiple different accents that differ from the speaker's primary or source accent, using the same transcript. That is, the TTS model may generate training data for the accent conversion model that includes examples of differently accented speech of the same speaker for the same transcript. For example, the TTS model may generate training data that includes speech from a speaker in a first accent and speech from the same speaker in a second accent. An alignment module may align frames of accented speech included in the training data according to, for example, a hard monotonic attention mechanism. The accent conversion model may be trained to modify speech based on the aligned training data.

The accent conversion model may be trained, based on aligned training data that may be generated using the TTS model or another method, to map spectral characteristics associated with a first accent of input audio to spectral characteristics associated with a second, requested accent. For example, the accent conversion model may include an autoencoder having a neural network with a U-Net architecture trained to map spectral magnitudes of an original speech waveform to spectral magnitudes of an accent shifted waveform learned based on the aligned training data. Spectral magnitudes may include a magnitude or amplitude of frequency components in a spectrum domain associated with audio waveforms. The accent conversion model may be trained to determine spectral magnitudes of an accent shifted waveforms by generating a first spectral magnitude of a first accented speech waveform included in an instance of the aligned trained data that includes spectral characteristics of the first accent speech waveform. The accent conversion model may map the first spectral magnitude to a second spectral magnitude by converting accent characteristics of the first accented speech waveform within a spectral domain. The accent conversion model may determine whether the mapped second spectral magnitude corresponds to a spectral magnitude included in the same instance of aligned training data as the first accented speech waveform and adjust parameters of the accent conversion model accordingly.

At the inference phase, the accent conversion model may obtain a speech waveform of a speaker speaking in a first accent. The accent conversion model may decompose the speech waveform to a short-time magnitude and a short-time phase. The accent conversion model may process the short-time magnitude to map segments of spectral magnitudes corresponding to the first accent to segments of spectral magnitudes corresponding to a second accent. For example, the accent conversion model may map segments of spectral magnitudes corresponding to the first accent to segments of spectral magnitudes corresponding to the second accent based on a conversion of spectral characteristics of the first accent to spectral characteristics of the second accent learned during the training phase. The accent conversion model may generate an accented speech waveform by combining the short-time phase of the original speech waveform and the spectral magnitudes corresponding to the second accent. The accent conversion model may output the accented speech waveform as a modified version of the original speech waveform. The accent conversion model may output the accented speech waveform to a teleconferencing system, telephony application, video player, streaming service, or other software application for real-time accent modification of input speech.

The techniques may provide one or more technical advantages that realize at least one practical application. For example, the TTS model may be able to generate large amounts of aligned training data for many different accents. The TTS model may disentangle speech characteristics from accent characteristics to generate any large number of synthetic speech clips to include in the large amounts of aligned training data. The TTS model may learn to disentangle accent characteristics from sample speech clips to train an accent conversion model to generate accented speech from original speech from a speaker that may not have been included in the training of the TTS model. The accent conversion model may be trained, based on training data generated by the TTS model, to generate accented speech from original speech in real-time by learning to map characteristics of an original accent of speech to characteristics of a different accent. In general, the TTS model may provide phonetic context (e.g., context of accent characteristics) to the accent conversion model to train the accent conversion model to accurately and efficiently generate accented speech from original speech.

In one example, a method includes obtaining a dataset of a plurality of sample speech clips. The method may further include generating a plurality of sequence embeddings based on the plurality of sample speech clips. The method may further include initializing a plurality of speaker embeddings and a plurality of accent embeddings. The method may further include updating the plurality of speaker embeddings based on the plurality of sample speech clips. The method may further include updating the plurality of accent embeddings based on the plurality of sample speech clips. The method may further include generating a plurality of augmented embeddings based on the plurality of sequence embeddings, the plurality of speaker embeddings, and the plurality of accent embeddings. The method may further include generating a plurality of synthetic speech clips based on the plurality of augmented embeddings.

In another example, a computing system may include processing circuitry and memory for executing a machine learning system. The machine learning system may be configured to obtain a dataset of a plurality of sample speech clips. The machine learning system may further be configured to generate a plurality of sequence embeddings based on the plurality of sample speech clips. The machine learning system may further be configured to initialize a plurality of speaker embeddings and a plurality of accent embeddings. The machine learning system may further be configured to update the plurality of speaker embeddings based on the plurality of sample speech clips. The machine learning system may further be configured to update the plurality of accent embeddings based on the plurality of sample speech clips. The machine learning system may further be configured to generate a plurality of augmented embeddings based on the plurality of sequence embeddings, the plurality of speaker embeddings, and the plurality of accent embeddings. The machine learning system may further be configured to generate a plurality of synthetic speech clips based on the plurality of augmented embeddings.

In another example, computer-readable storage media may include machine readable instructions for configuring processing circuitry to obtain a dataset of a plurality of sample speech clips. The processing circuitry may further be configured to generate a plurality of sequence embeddings based on the plurality of sample speech clips. The processing circuitry may further be configured to initialize a plurality of speaker embeddings and a plurality of accent embeddings. The processing circuitry may further be configured to update the plurality of speaker embeddings based on the plurality of sample speech clips. The processing circuitry may further be configured to update the plurality of accent embeddings based on the plurality of sample speech clips. The processing circuitry may further be configured to generate a plurality of augmented embeddings based on the plurality of sequence embeddings, the plurality of speaker embeddings, and the plurality of accent embeddings. The processing circuitry may further be configured to generate a plurality of synthetic speech clips based on the plurality of augmented embeddings.

In one example, a method includes obtaining an audio waveform. The method may further include decomposing the audio waveform into first one or more magnitude spectral slices and an original phase. The method may further include processing, by an autoencoder trained based on accented speech clips with aligned phonemes, the first one or more magnitude spectral slices to map the first one or more magnitude spectral slices associated with a source accent to second one or more magnitude spectral slices associated with a target accent. The method may further include generating a modified audio waveform in part by combining the second one or more magnitude spectral slices and the original phase.

In another example, a computing system may include processing circuitry and memory for executing a machine learning system. The machine learning system may be configured to obtain an audio waveform. The machine learning system may further be configured to decompose the audio waveform into first one or more magnitude spectral slices and an original phase. The machine learning system may further be configured to process, by an autoencoder trained based on accented speech clips with aligned phonemes, the first one or more magnitude spectral slices to map the first one or more magnitude spectral slices associated with a source accent to second one or more magnitude spectral slices associated with a target accent. The machine learning system may further be configured to generate a modified audio waveform in part by combining the second one or more magnitude spectral slices and the original phase.

In another example, computer-readable storage media may include machine readable instructions for configuring processing circuitry to obtain an audio waveform. The processing circuitry may further be configured to decompose the audio waveform into first one or more magnitude spectral slices and an original phase. The processing circuitry may further be configured to process, by an autoencoder trained based on accented speech clips with aligned phonemes, the first one or more magnitude spectral slices to map the first one or more magnitude spectral slices associated with a source accent to second one or more magnitude spectral slices associated with a target accent. The processing circuitry may further be configured to generate a modified audio waveform in part by combining the second one or more magnitude spectral slices and the original phase.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 is a block diagram illustrating an example computing environment for modifying speech, in accordance with the techniques of the disclosure.

FIG. 2 is a block diagram illustrating an example computing system for generating training data, in accordance with the techniques of the disclosure.

FIG. 3 is a block diagram illustrating an example computing system for modifying speech, in accordance with the techniques of the disclosure.

FIG. 4 is flowchart illustrating an example mode of operation for training an accent conversion model to modify speech, in accordance with the techniques of the disclosure.

FIG. 5 is a conceptual diagram illustrating alignment of accented speech clips included in training data, in accordance with the techniques of the disclosure.

FIG. 6 is a flowchart illustrating an example mode of operation for generating synthetic speech, in accordance with the techniques of this disclosure.

FIG. 7 is a flowchart illustrating an example mode of operation for modifying speech, in accordance with the techniques of this disclosure.

Like reference characters refer to like elements throughout the figures and description.

### DETAILED DESCRIPTION

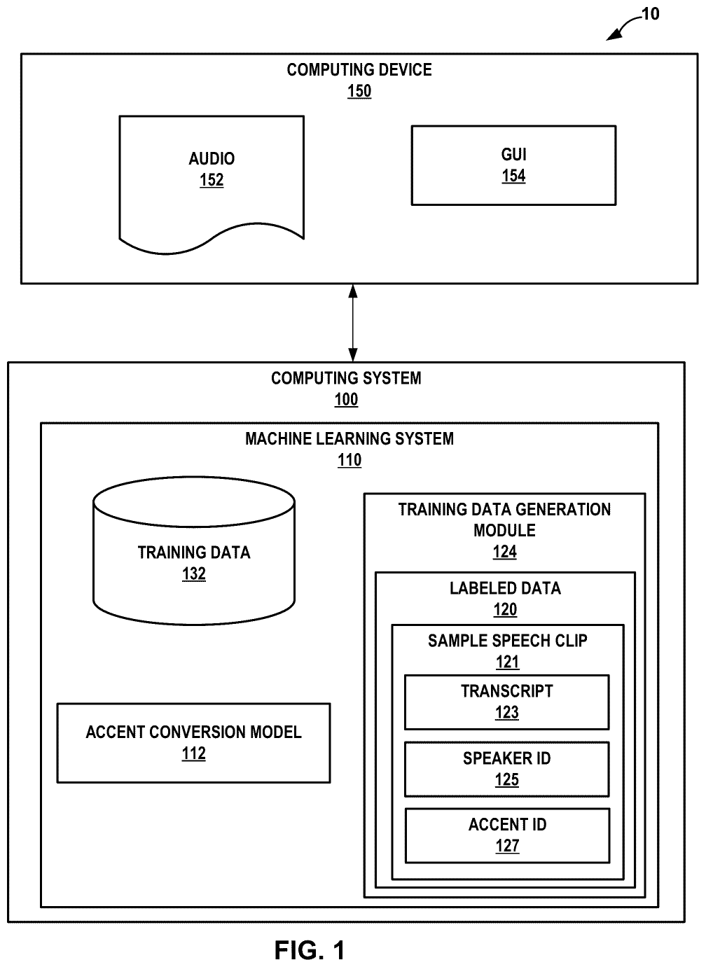

FIG. 1 is a block diagram illustrating example computing environment 10 for modifying speech, in accordance with the techniques of the disclosure. Computing environment 10 includes computing system 100 and computing device 150. Computing device 150 may include a mobile computing device, such as a mobile phone (including a smartphone), a laptop computer, a tablet computer, a wearable computing device, or any other computing device. In the example of FIG. 1, computing device 150 may include audio 152 and graphical user interface (GUI) 154. Audio 152 may include an audio file with audio waveforms representing speech from a speaker in the speaker's original accent. GUI 154 may include a user interface that may be associated with functionality of computing device 150. For example, GUI 154 of FIG. 1 may include a user interface for an application associated with a modifying or cloning speech, such as the speech included in audio 152. Although illustrated in FIG. 1 as internal to computing device 150, GUI 154 may be output for display on an external display device. In some examples, GUI 154 may provide an option for a user of computing device 150 to input labeled training speech clips (e.g., labeled data 120) of various speakers speaking with an accent a user wants to convert speech of audio 152 according to (e.g., a target accent). Although illustrated as external to computing system 100, computing device 150 may be a component of computing system 100. Although not shown, computing device 150 and computing system 100 may communicate via a communication channel, which may include a network, such as the Internet, another public or private communications network, for instance, broadband, cellular, Wi-Fi, ZigBee, Bluetooth® (or other personal area network-PAN), Near-Field Communication (NFC), ultrawideband, satellite, enterprise, service provider and/or other types of communication networks or communication channels for transmitting data between computing systems, servers, and computing devices.

Computing system 100 may represent one or more computing devices configured to execute machine learning system 110. Machine learning system 110 may be trained to modify accent of speech included in an audio waveform, in some cases in real time or near real time. Computing system 100 may represent a dedicated conferencing system, such as a videoconferencing or teleconferencing system, a computing system executing a conferencing application, video application, audio or telephony application, audio/video recording application, or other application that receives and processes audio from a user.

In the example of FIG. 1, machine learning system 110 includes training data generation module 124, training data 132, and accent conversion model 112. Training data generation module 124 may include a software module with computer-readable instructions for generating training data 132. Training data generation module 124 may generate, using a text-to-speech (TTS) model, synthetic speech clips to create instances of aligned training data stored as training data 132. Training data 132 may be stored to a storage device (e.g., short-term and/or long-term memory devices) that stores instances of training data generated by training data generation module 124. Accent conversion model 112 is trained, based on training data 132, to modify speech to generate differently-accented speech. Accent conversion model 112 may include a software module with computer-readable instructions for implementing a neural network (e.g., a neural network with a U-Net architecture) accented speech based on training data 132 and an original audio waveform (e.g., audio 152).

In accordance with the techniques described herein, computing system 100 executing machine learning system 110 may modify speech. Training data generation module 124 may generate training data 132 for training accent conversion model 112 to modify speech. For example, training data generation module 124 may include a TTS model trained to synthesize speech based on sample speech clips (e.g., sample speech clip 121) included in a large dataset of speech clips (e.g., labeled data 120). Training data generation module 124 may receive labeled data 120 from computing device 150 or an administrator of computing system 100. Labeled data 120 may include a dataset of sample speech clips that have been manually labeled. For example, sample speech clip 121 of labeled data 120 may be labeled with transcript 123, speaker identifier (ID) 125, and accent identifier (ID) 127. Transcript 123 may include input text associated with speech in sample speech clip 121. Speaker ID 125 may include an identifier, reference, address, or other value specifying an identity of a speaker associated with sample speech clip 121. Accent ID 127 may include an identifier, reference, address, or other value specifying a source accent of the speaker associated with sample speech clip 121.

Training data generation module 124 may train the TTS model to generate sequence embeddings based on labeled data 120. A sequence embedding may include a high-dimensional vector representation of characteristics of a sequence of input symbols (e.g., characters, phonemes, graphemes, or other linguistic features). Training data generation module 124 may define a vector dimensionality of sequence embeddings by providing the TTS model a model hyperparameter specifying a type of input symbol (e.g., phoneme or grapheme), an architecture of the TTS model, and/or task requirements (e.g., fine-grained semantic distinctions, computational efficiency for real-time speech synthesis, etc.). Training data generation module 124 may generate sequence embeddings to include vector representations that capture semantic and contextual information of the sequence of input symbols based on sample speech clips of labeled data 120. For example, training data generation module 124 may generate one or more sequence embeddings by processing transcript 123 of sample speech clip 121 to identify and encode each phoneme or grapheme included in audio of sample speech clip 121. Training data generation module 124 may convert text (e.g., characters or strings) of transcript 123 into sequence embeddings by mapping (e.g., based on a phonetic analysis and segmentation of the labeled transcript) each identified phoneme or grapheme to a high-dimensional vector space, where phonemes or graphemes with similar properties (e.g., similar acoustic properties) are represented closer to each other in the mapping. Training data generation module 124 may encode semantic and syntactic structure of input text (e.g., transcript 123), where the encoded semantic and syntactic structures are typically shared across all speakers. In general, training model 124 may generate sequence embeddings that capture phonetic information of text sequences based on text transcripts of sample speech clips included in labeled data 120.

Training data generation module 124 may train the TTS model to generate speaker embeddings. A speaker embedding may include a high-dimensional vector representation of characteristics of a speaker's voice (e.g., timbre, intonation, or other acoustic properties). Training data generation module 124 may determine a vector dimensionality of speaker embeddings based on a model hyperparameter specifying a complexity of speaker characteristics the TTS model will be trained to capture. For example, training data generation module 124 may provide the TTS model a model hyperparameter defining speaker embeddings with hundreds of dimensions to capture more complex speaker characteristics compared to a model hyperparameter defining speaker embeddings with ten dimensions. Training data generation module 124 may randomly initialize speaker embeddings for each unique speaker identifier of sample speech clips included in labeled data 120. For example, training data generation module 124 may randomly initialize a speaker embedding for speaker ID 125 by determining the dimensionality of speaker embeddings (e.g., based on a model hyperparameter) and generating random values for each dimension of the speaker embedding. Training data generation module 124 may maintain a lookup table that maps or associates each unique speaker identifier with a corresponding randomly initialized speaker embedding. Training data generation module 124 may implement the lookup table using dictionaries, arrays, database indexes, or other data structure that allows efficient retrieval of speaker embeddings based on a speaker identifier.

Training data generation module 124 may train the TTS model to update the randomly initialized speaker embeddings based on labeled data 120. For example, training data generation module 124 may update a randomly initialized speaker embedding associated with speaker ID 125 by providing the TTS model sample speech clip 121. Training data generation module 124 may identify and generate speaker encoding information (e.g., pitch, intonation, speaking rate, etc.) associated with a unique vocal identity of a speaker associated with speaker ID 125 based on audio of sample speech clip 121. For example, training data generation module 124 may generate speaker encoding information as a vector representation of extracted relevant features (e.g., mel-frequency cepstral coefficients, fundamental frequency, formant frequencies, energy contour, prosodic features, etc.) from a speech signal derived from audio waveforms of audio included in sample speech clip 121. Training data generation module 124 may use the lookup table to retrieve the randomly initialized speaker embedding associated with speaker ID 125, and update the randomly initialized speaker embedding based on the speaker encoding information. For example, training data generation module 124 may update the randomly initialized speaker embedding by replacing values of the randomly initialized speaker embedding with values of the speaker encoding information. In general, training data generation module 124 may tune a speaker embedding for a speaker by updating the speaker embedding based on speaker encoding information for different sample speech clips labeled with the same speaker identifier.

Training data generation module 124 may train the TTS model to generate accent embeddings. An accent embedding may include a high-dimensional vector representation of characteristics of an accent (e.g., Irish accent, Scottish accent, Indian accent, southern accent, African-American Vernacular English, etc.). Training data generation module 124 may determine a vector dimensionality of accent embeddings based on a model hyperparameter specifying a complexity of accent characteristics the TTS model will be trained to capture. For example, training data generation module 124 may provide the TTS model a model hyperparameter defining accent embeddings with hundreds of dimensions to capture more complex accent characteristics compared to a model hyperparameter defining accent embeddings with ten dimensions. Training data generation module 124 may randomly initialize accent embeddings for each unique accent identifier of sample speech clips included in labeled data 120. For example, training data generation module 124 may randomly initialize an accent embedding for accent ID 127 by determining the dimensionality of accent embeddings (e.g., based on a model hyperparameter) and generating random values for each dimension of the accent embedding. Training data generation module 124 may maintain a lookup table that maps or associates each unique accent identifier with a corresponding randomly initialized accent embedding. Training data generation module 124 may implement the lookup table using dictionaries, arrays, database indexes, or other data structure that allows efficient retrieval of accent embeddings based on an accent identifier.

Training data generation module 124 may train the TTS model to update the randomly initialized accent embeddings based on labeled data 120. For example, training data generation module 124 may update a randomly initialized accent embedding associated with accent ID 127 by providing the TTS model sample speech clip 121. Training data generation module 124 may identify and generate accent encoding information (e.g., pronunciation, stress of certain syllables or words, intonation, etc.) associated with a unique accent identity of an accent associated with accent ID 127 based on audio of sample speech clip 121. For example, training data generation module 124 may generate accent encoding information as a vector representation of extracted relevant features (e.g., mel-frequency cepstral coefficients, fundamental frequency, formant frequencies, energy contour, prosodic features, etc.) from a speech signal derived from audio waveforms of audio included in sample speech clip 121. Training data generation module 124 may use the lookup table to retrieve the randomly initialized accent embedding associated with accent ID 127, and update the randomly initialized accent embedding based on the accent encoding information. For example, training data generation module 124 may update the randomly initialized accent embedding by replacing values of the randomly initialized accent embedding with values of the accent encoding information. In general, training data generation module 124 may tune an accent embedding for an accent by updating the accent embedding based on accent encoding information for different sample speech clips labeled with the same accent identifier.

Training data generation module 124 may train the TTS model to disentangle speech information from accent information with generated accent embeddings. Although the TTS model of training data generation module 124 may encode similar features in speaker embeddings and accent embeddings, the TTS model may disentangle other speech information attributable to a particular speaker, and not relating to accent, (e.g., vocal tract length, individual speaking idiosyncrasies, etc.) from accent information attributable to an entire dialect group (e.g., monophthongal “aa” in Southern English for “ai” in a word such as “buy”) by learning to tune speaker embeddings based on similarities between different sample speech clips labeled with the same speaker identifier and learning to create distinct accent embeddings based on similarities between different sample speech clips labeled with the same accent identifier, which may include features not included in speaker embeddings of sequence embeddings. Training data generation module 124 may train the TTS model to control for idiosyncratic speaker characteristics when learning accent embeddings, while also controlling for accent characteristics when learning speaker embeddings. In this way, training data generation module 124 may train the TTS model to tune speaker embeddings and accent embeddings to capture different information. In other words, training data generation module 124 may continuously tune speaker embeddings based on speaker characteristics associated with audio of sample speech clips of labeled data 120 labeled with the same speaker identifier, while also continuously tuning accent embeddings based on accent characteristics associated with audio of sample speech clips of labeled data 120 labeled with the same accent identifier. In general, training data generation module 124 may train the TTS model to tune two different types of speech-based embedding representations, speaker embeddings capturing the speaker characteristics and accent embeddings capturing accent characteristics.

Training data generation module 124 may generate a sequence of augmented embeddings based on the sequence embeddings, the speaker embeddings, and the accent embeddings. Training data generation module 124 may generate the sequence of augmented embeddings by, for example, summing each sequence embedding with the speaker embeddings and the accent embeddings for each symbol in an input sequence. Training data generation module 124 may generate augmented embeddings that include speaker information and accent information.

Training data generation module 124 may generate synthetic speech based on the augmented embeddings. For example, training data generation module 124 may input the augmented embeddings to a portion of the TTS model including an encoder, decoder, and a series of deconvolutional networks to generate synthetic speech clips. Training data generation module 124 may generate synthetic speech clips for speakers in different accents. For example, training data generation module 124 may generate a first synthetic speech clip of a speaker speaking in a first accent and a second synthetic speech clip of the speaker speaking in a second accent. Training data generation module 124 may generate the first synthetic speech clip of the speaker in the first accent and the second synthetic speech clip of the speaker the second accent by preserving all other non-accent aspects of a voice (e.g., voice, quality, prosody, etc.) that may be captured in the speaker embedding associated with the speaker. Training data generation module 124 may pair synthetic speech clips associated with the same speaker speaking in different accents to create an instance of training data. Training data generation module 124 may align frames of synthetic speech clips included in instances of training data. A segment is a sequence of audio frames (“frames”), and each frame is a number of audio samples representing the amplitude of the audio signal at spaced points in time. The points in time are typically equally-spaced, and frames typically have a common, fixed number of audio samples per frame. Frames in a segment may have overlapping audio samples.

Training data generation module 124 may align synthetic speech clips. Training data generation module 124 may align synthetic speech clips based on a frame-by-frame alignment. For example, training data generation module 124 may inspect the weight of a hard monotonic attention mechanism used by a TTS model of training data generation module 124 when synthesizing a clip of synthetic speech. In other words, after training data generation module 124 generates a clip of synthetic speech, training data generation module 124 may determine which symbol of a text transcription to which the TTS model directed attention. For example, training data generation module may generate a first synthetic speech clip where frames 110-115 of the first synthetic speech clip for a first accent were generated while attending to the “a” in the word “cats” in the transcript. Training data generation module 124 may align the first synthetic speech clip for the first accent with frames 98-102 of a second synthetic speech clip for a second accent if the same symbol was attended to in that clip over those frames. In other words, training data generation module 124 may align frames from different synthetic speech clips with the same accent based on the same symbol being attended to in respective synthetic speech clips when generating the synthetic speech clip. Training data generation module 124 may generate an instance of training data to include timestamps corresponding to aligned frames of each synthetic speech clip included in the instance of training data based on the weights of the hard monotonic attention mechanism implemented by the TTS model. For example, training data generation module 124 may generate an instance of training data to include a first timestamp of the first synthetic speech clip and a second timestamp of the second synthetic speech clip, wherein the first timestamp corresponds to frames 110-115 and the second timestamp corresponds to frames 98-102. Training data generation module 124 may include the timestamps as metadata of the instances of training data. Training data generation module 124 may store instances of training data with aligned synthetic speech clips at training data 132. In some instances, training data generation module 124 may store an instance of training data at training data 132 to include synthetic speech from the same speaker but in various accents. In some examples, training data generation module 124 may update speaker embeddings based on the samples speech clips of labeled data 120 using the aligned synthetic speech clips.

Computing system 100, or more specifically, for example, accent conversion model 112 may modify speech based on training data 132. Accent conversion model 112 may be trained based on accented speech clips with aligned phonemes. For example, accent conversion model 112 may be trained to generate spectral magnitudes for synthetic speech based on phoneme-aligned frames included in instances of training data 132. Accent conversion model 112 may generate spectral magnitudes to include a magnitude or amplitude of frequency components in a spectrum domain associated with audio waveforms. Accent conversion model 112 may generate spectral magnitudes to represent frequency content and energy distribution associated with audio waveforms of speech. Accent conversion model 112 may learn to map generated spectral magnitudes for a first synthetic speech clip associated with a source accent to spectral magnitudes for a second synthetic speech clip associated with a target or requested accent. For example, accent conversion model 112 may map a first spectral magnitude for a synthetic speech clip in a first accent included in an instance of training data stored at training data 132 to a second spectral magnitude in a target accent. Accent conversion model 112 may map the first spectral magnitude to the target spectral magnitude by converting spectral characteristics of the first spectral magnitude according to accent characteristics included in the target spectral magnitude. Accent conversion model 112 may map the first spectral magnitude to the target spectral magnitude by adjusting the first spectral magnitude based on accent characteristics of the target accent. Accent conversion model 112 may compare the target spectral magnitude to a third spectral magnitude included in the same instance of training data as the first spectral magnitude and associated with the target accent. Accent conversion model 112 may adjust parameters (e.g., weights of a neural network included in accent conversion model 112) based on a calculated loss function associated with the comparison of the target spectral magnitude and the third spectral magnitude.

Computing system 100 may modify speech by converting an accent in an original audio waveform (e.g., audio 152) to a different accent in a modified audio waveform. Computing system 100 may obtain audio 152 from computing device 150. For example, computing device 150 may receive, via GUI 154, an indication from a user operating computing device 150 to send audio 152 to computing system 100 to modify speech of audio 152 to speech in a different accent. Computing system 100 may obtain audio 152 and an indication of a requested or target accent to modify audio 152 according to.

Accent conversion model 112 may decompose an audio waveform of audio 152. For example, accent conversion model 112 may compute a short-time Fourier transform (STFT) from the audio waveform and decompose the STFT to a short-time magnitude and a short-time phase for the audio waveform. Accent conversion model 112 may create first segments of spectral magnitudes based on the short-time magnitude. Accent conversion model 112 may create segments of spectral magnitudes by, for example, dividing the short-time magnitude into segments or bins that represent a specific frequency range that allow for the quantification of energy distribution across different frequency bands of an audio signal. Accent conversion model 112 may include a machine learning model (e.g., a deep convolutional U-Net) trained to map the first segments of spectral magnitudes to second segments of spectral magnitudes associated with the target accent. Accent conversion model 112 may map the first segments of spectral magnitudes to the second segments of spectral magnitudes by converting spectral characteristics of the first segments of spectral magnitudes to spectral characteristics associated with the target accent. Accent conversion model 112 may combine the second segments of spectral magnitudes associated with the target accent with the short-time phase to generate a modified audio waveform. For example, accent conversion model 112 may apply an algorithm (e.g., a Griffin-Lim algorithm) to generate the modified audio waveform based on the spectral magnitudes associated with the target accent and the short-time phase. Computing system 100 may output the modified audio waveform to a teleconferencing system, a telephony application, a social media platform, a streaming platform, a streaming service, or other software applications configured for real-time communication. In some instances, computing system 100 may output the modified audio waveform to computing device 150 as an audio file including the same words and speaker characteristics of audio 152 but spoken in the target accent.

The techniques may provide one or more technical advantages that realize at least one practical application. For example, training data generation module 124 of computing system 100 may be able to generate aligned training data for many different accents. Training data generation module 124 may include a TTS model fine-tuned to disentangle speech characteristics from accent characteristics to generate synthetic speech clips of a speaker speaking with different accents. Training data generation module 124 may learn to disentangle accent characteristics from sample speech clips to train accent conversion model 112 to generate accented speech from original speech from a speaker that may not have been included in the training of a TTS model of training data generation module 124. Training data generation module 124 may generate synthetic training data 132 for various applications based on the finer control the TTS model of training data generation module 124 has over speaker characteristics in synthesized speech. In some instances, training data generation module 124 may implement the techniques described herein to train the TTS model to disentangle other speech characteristics (e.g., whispering, shouting, creaky speech, environmental noise, etc.). In some examples, training data generation module 124 may generate training data 132 to train a machine learning model to improve automatic speech recognition of a target speaker's voice based on training instances that include disentangled speaker characteristics. In general, training data generation module 124 may generate training data 132 to train accent conversion model 112 to provide phonetic context of learned accents to a neural network that generates a target, native spectral sequence based on training instances of training data 132.

Accent conversion model 112 may be trained, based on training data 132, to generate accented speech from original speech in real-time by learning to map characteristics of an original accent of speech to characteristics of a different, target accent. Accent conversion model 112 may modify, in real-time, a spectral envelope of a speaker's speech (e.g., audio 152) to approximate that of a native speaker. Accent conversion model 112 may improve the speech accent of non-native speakers in settings where speech of the speakers is passed through a communication channel, such as video conferencing. In this way, accent conversion model 112 may modify speech from a speaker with a heavy accent to communicate and give presentations that may improve intelligibility (e.g., modifying speech in a way that is easier for listeners to understand). Accent conversion model 112 may modify speech from a speaker with a heavy accent to speech with a more native accent that matches expectations of the audience or interlocutor, while keeping the same voice of the speaker constant (e.g., maintaining personal identity based on disentangling speaker characteristics from accent characteristics). In some instances, accent conversion model 112 may be trained, based on training data 132, in gaming applications, such as having a speaker provide speech for a first character in a first accent while also providing speech for a second character in a second accent or having an avatar speak in a user's voice but with a different accent.

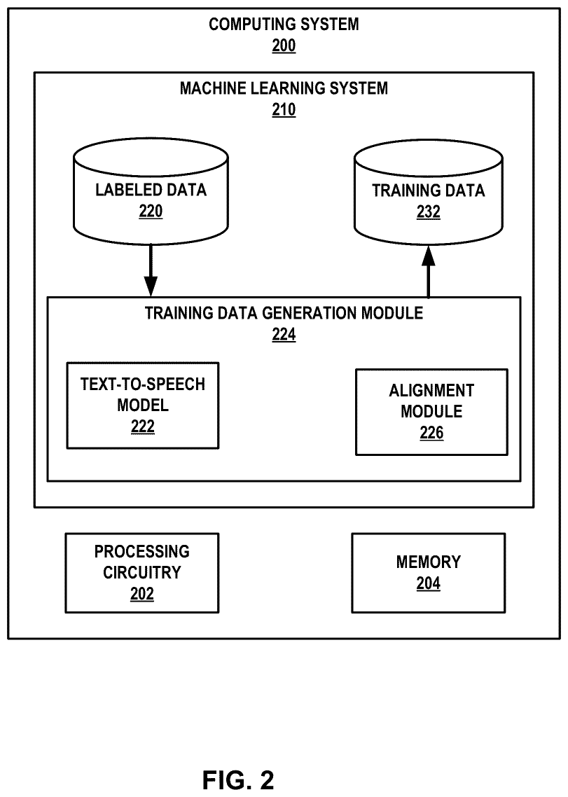

FIG. 2 is a block diagram illustrating example computing system 200 for generating training data, in accordance with the techniques of the disclosure. Computing system 200, machine learning system 210, training data generation module 224, training data 232, and labeled data 220 of FIG. 2 may be example or alternative implementations of computing system 100, machine learning system 110, training data generation module 124, training data 132, and labeled data 120 of FIG. 1, respectively. Computing system 200, in the example of FIG. 2, may include processing circuitry 202 having access to memory 204. Processing circuitry 202 and memory 204 may be configured to execute training data generation module 224 of machine learning system 210 to generate training data with synthetic speech clips of speakers speaking in various accents, according to techniques of this disclosure.

Computing system 200 comprises any suitable computing system having one or more computing devices, such as desktop computers, laptop computers, gaming consoles, smart televisions, handheld devices, tablets, mobile telephones, smartphones, etc. In some examples, at least a portion of system 200 is distributed across a cloud computing system, a data center, or across a network, such as the Internet, another public or private communications network, for instance, broadband, cellular, Wi-Fi, ZigBee, Bluetooth® (or other personal area network—PAN), Near-Field Communication (NFC), ultrawideband, satellite, enterprise, service provider and/or other types of communication networks, for transmitting data between computing systems, servers, and computing devices.

Memory 204 may store information for processing during operation of training data generation module 224. In some examples, memory 204 may include temporary memories, meaning that a primary purpose of the one or more storage devices is not long-term storage. Memory 204 may be configured for short-term storage of information as volatile memory and therefore not retain stored contents if deactivated. Examples of volatile memories include random access memories (RAM), dynamic random access memories (DRAM), static random access memories (SRAM), and other forms of volatile memories known in the art. Memory 204, in some examples, also include one or more computer-readable storage media. Memory 204 may be configured to store larger amounts of information than volatile memory. Memory 204 may further be configured for long-term storage of information as non-volatile memory space and retain information after activate/off cycles. Examples of non-volatile memories include magnetic hard disks, optical discs, floppy disks, Flash memories, or forms of electrically programmable memories (EPROM) or electrically erasable and programmable (EEPROM) memories. Memory 204 may store program instructions and/or data associated with one or more of the modules (e.g., training data generation module 224 of machine learning system 210) described in accordance with one or more aspects of this disclosure.

Processing circuitry 202 and memory 204 may provide an operating environment or platform for training data generation module 224, which may be implemented as software, but may in some examples include any combination of hardware, firmware, and software. Processing circuitry 202 may execute instructions and memory 204 may store instructions and/or data of one or more modules. The combination of processing circuitry 202 and memory 204 may retrieve, store, and/or execute the instructions and/or data of one or more applications, modules, or software. Processing circuitry 202 and memory 204 may also be operably coupled to one or more other software and/or hardware components, including, but not limited to, one or more of the components illustrated in FIG. 2. Processing circuitry 202 and memory 204 may each be distributed over one or more computing devices.

In the example of FIG. 2, machine learning system 210 may include labeled data 220, training data 232, and training data generation module 224. Training data generation module 224 of machine learning system 210 may include text-to-speech (TTS) model 222 and alignment module 226. TTS model 222 may include a software module with computer-readable instructions for a machine learning model trained to generate synthetic speech of a speaker in different accents based on sample speech clips included in labeled data 220. Alignment module 226 may include a software module with computer-readable instructions for aligning synthetic speech output by TTS model 222 based on frame-by-frame time alignment techniques, for example.

In accordance with the techniques described herein, training data generation module 224 of machine learning system 210 may generate training data 232 to train an accent conversion module (e.g., accent conversion module 112 of FIG. 1). TTS model 222 may be trained to generate synthetic speech based on labeled data 220. Labeled data 220 may include a plurality of sample speech clips that may have been manually labeled with text transcripts, speaker identifiers, and accent identifiers. For example, labeled data 220 may include a sample speech clip with a text transcript corresponding to speech included in the sample speech clip, an identifier representing the speech in the sample speech clip is spoken by a first speaker, and an identifier representing the speech in the sample speech clip is spoken in a first accent (e.g., African-American Vernacular English, Indian accented English, etc.). Labeled data 220 may include speech clips with metadata that includes corresponding labels for the speech clips. In some examples, labeled data 220 may include sample speech clips that have been manually labeled by an administrator operating computing system 200. Computing system 200 may provide labeled data 220 to TTS model 222 of training data generation module 224. TTS model 222 may be trained to generate synthetic speech based on labeled data 220 by generating sequence embeddings, speaker embeddings, and accent embeddings.

TTS model 222 may generate sequence embeddings based on text transcripts of sample speech clips included in labeled data 220. For example, TTS model 222 may annotate a text transcript corresponding to a sample speech clip to identify strings of phoneme symbols by, for example, segmenting the text transcript into individual phonemes. TTS model 222 may extract features to represent phonetic content of sample speech clips of labeled data 220 based on the strings of phoneme symbols. TTS model 222 may extract features such as linguistic features, contextual information, or the like. TTS model 222 may generate sequence embeddings based on the extracted features. In some examples, TTS model 222 may generate sequence embeddings based on the extracted features through an application of backpropagation and gradient descent optimization that iteratively adjust model parameters of TTS model 222 to minimize a loss function that measures a discrepancy between a predicted sequence embedding and a ground truth sequence embedding. In general, TTS model 222 may generate sequence embeddings in a high-dimensional vector space (e.g., a vector space where each dimension corresponds to a learned feature or attribute of a phoneme) that captures acoustic properties, contextual relationships, and linguistic characteristics associated with each phoneme of sample speech clips included in labeled data 220.

TTS model 222 may generate speaker embeddings based on speaker identifiers of sample speech clips included in labeled data 220. TTS model 222 may randomly initialize a speaker embedding for each speaker corresponding to speaker identifiers included in labels of sample speech clips of labeled data 220. TTS model 222 may update speaker embeddings by encoding features representing speech characteristics of a speaker identified by a label stored in metadata of the sample speech clip. TTS model 222 may encode features such as pitch contours, speaking rate, intonation patterns, spectral characteristics, or other prosodic features that capture a unique aspect of a speaker's voice identity. TTS model 222 may update a speaker embedding for a speaker based on features extracted for speech clips associated with the speaker (e.g., based on the speaker identified in labels corresponding to the speech clips). TTS model 222 may learn to update speaker embeddings with techniques such as backpropagation and gradient descent that iteratively adjusts model parameters of TTS model 222 to minimize a loss function measuring a discrepancy between a predicted speaker embedding and a ground truth speaker embedding. In general, TTS model 222 may generate speaker embeddings in a high-dimensional vector space (e.g., a vector space where each dimension corresponds to a learned feature or attribute of a speaker's voice) that captures acoustic properties, prosodic patterns, and speaker styles associated with each speaker identified in sample speech clips of labeled data 220.

TTS model 222 may generate accent embeddings based on accent identifiers of sample speech clips of labeled data 220. During the training phase of TTS model 222, TTS model 222 may randomly initialize accent embeddings for each accent corresponding to an accent identifier of a sample speech clip of labeled data 220. TTS model 222 may learn to disentangle accent information and speaker information. For example, TTS model 222 may update a randomly initialized accent embedding for a sample speech clip of labeled data 220 by encoding features representing accent characteristics corresponding to an accent identified by a label stored in metadata of the sample speech clip. TTS model 222 may encode features such as pronunciation, stress of a syllable or word, intonations, or other features that capture a unique aspect of accented speech. TTS model 222 may update an accent embedding for an accent based on accent features of speech clips labeled with the accent. TTS model 222 may learn to update accent embeddings with techniques such as backpropagation and gradient descent that iteratively adjusts model parameters of TTS model 222 to minimize a loss function measuring a discrepancy between a predicted accent embedding and a ground truth accent embedding. In general, TTS model 222 may generate accent embeddings in a high-dimensional vector space (e.g., a vector space where each dimension corresponds to a learned feature or attribute of an accent) that captures properties, patterns, and styles associated with each accent identified in sample speech clips of labeled data 220.

TTS model 222 may generate a sequence of augmented embeddings based on the sequence embeddings, speaker embeddings, and accent embeddings. TTS model 222 may generate the sequence of augmented by summing each sequence embedding with the speaker embedding and the accent embedding for each symbol in an input sequence. TTS model 222 may generate sequences of augmented embeddings that include speaker information and accent information. TTS model 222 may generate synthetic speech clips based on the augmented embeddings. For example, TTS model 222 may generate synthetic speech clips by providing an encoder, decoder, and a series of deconvolutional networks with the augmented embeddings. TTS model 222 may generate synthetic speech clips for speakers in different accents. Training data generation module 224 may pair synthetic speech clips associated with the same speaker speaking in different accents to create an instance of training data. For example, TTS model 222 may create an instance of training data to include a first synthetic speech clip of a speaker speaking in a first accent and a second synthetic speech clip of the speaker speaking in a second accent, and training data generation module 224 may associate the first and second synthetic speech clips.

Alignment module 226 may align synthetic speech clips generated by TTS model 222. Alignment module 226 may apply an alignment method (e.g., attention alignment mechanisms, forced alignment mechanisms, etc.) to align synthetic speech clips generated by TTS model 222. In one example, alignment module 226 may apply forced alignment methods by analyzing audio signals of synthetic speech clips and computing a sequence of acoustic feature vectors (e.g., Mel-frequency cepstral coefficients or spectrogram frames) at regular intervals or frames. In another example, TTS model 222 may generate synthetic speech clips to include weights of a hard monotonic attention mechanism. TTS model 222 may compute attention weights to determine which phoneme symbols TTS model 222 focused on when generating an output frame of a synthetic speech clip. TTS model 222 may select a single phoneme symbol as the focus of attention for each output frame of a synthetic speech clip. TTS model 222 may calculate an attention weight for an output frame of the synthetic speech clip based on the selected phoneme symbol. TTS model 222 may calculate attention weights that represent a relevance of each phoneme symbol for generating a corresponding synthetic speech clip. TTS model 222 may provide synthetic speech clips with corresponding attention weights to alignment module 226. Alignment module 226 may inspect the attention weights to determine, for each frame in a synthetic speech clip, what phoneme symbol in a text transcript TTS model 222 paid attention to. For example, alignment module 226 may determine that frames 110-115 of a first synthetic speech clip associated with a speaker speaking in a first accent was generated by attending to the phoneme symbol of “a” in the word “cats” of a text transcript associated with the first synthetic speech clip. Alignment module 226 may additionally determine that frames 98-102 of a second synthetic speech clip associated with the same speaker speaking in a second accent was generated by attending to the same phoneme symbol of “a” in the word “cats” in a text transcript associated with the second speech clip. Alignment module 226 may generate an instance of training data by pairing the first synthetic speech clip and the second synthetic speech clip, and labeling the first synthetic speech clip and the second synthetic speech clip based on the frame-by-frame time alignment. Alignment module 226 may label the first synthetic speech clip and the second synthetic speech clip with timestamps corresponding to a set of frames the first synthetic speech clip and the second synthetic speech clip include the same word as indicated in text transcripts associated with the first synthetic speech and the second synthetic speech. Alignment module 226 may store instances of training data as training data 232.

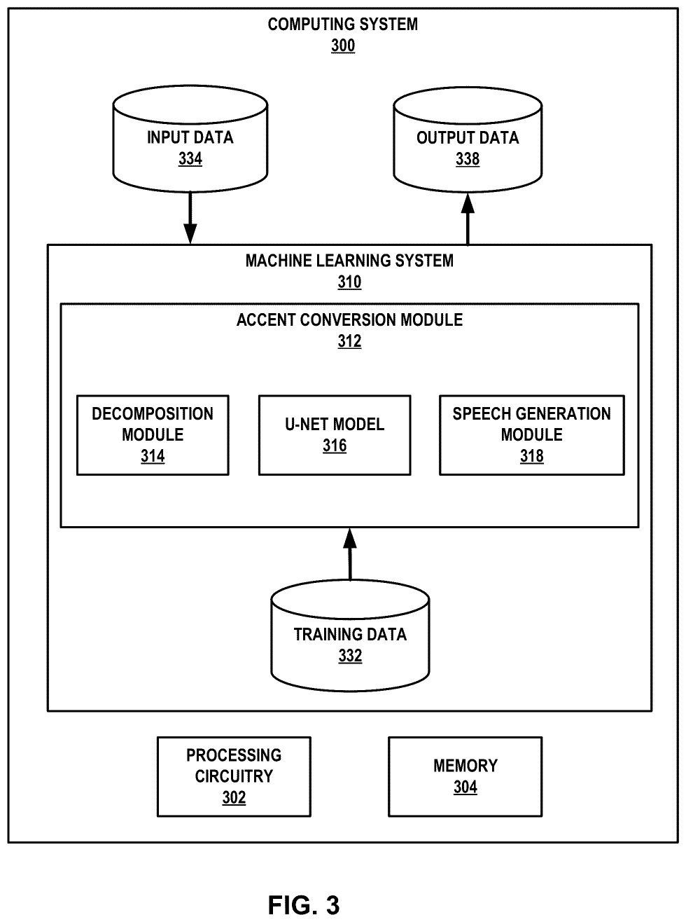

FIG. 3 is a block diagram illustrating example computing system 300 for modifying speech, in accordance with the techniques of the disclosure. Computing system 300, machine learning system 310, accent conversion module 312, and training data 332 of FIG. 3 may be example or alternative implementations of computing system 100, machine learning system 110, accent conversion module 112, and training data 132 of FIG. 1, respectively. Computing system 300, in the example of FIG. 3, may include processing circuitry 302 having access to memory 304. Processing circuitry 302 and memory 304 may be configured to execute accent conversion module 312 of machine learning system 310 to modify speech spoken in a source accent (e.g., a non-native accent) to speech spoken in a target accent (e.g., a native accent), according to techniques of this disclosure.

Computing system 300 comprises any suitable computing system having one or more computing devices, such as desktop computers, laptop computers, gaming consoles, smart televisions, handheld devices, tablets, mobile telephones, smartphones, etc. In some examples, at least a portion of system 300 is distributed across a cloud computing system, a data center, or across a network, such as the Internet, another public or private communications network, for instance, broadband, cellular, Wi-Fi, ZigBee, Bluetooth® (or other personal area network—PAN), Near-Field Communication (NFC), ultrawideband, satellite, enterprise, service provider and/or other types of communication networks, for transmitting data between computing systems, servers, and computing devices.

Memory 304 may store information for processing during operation of accent conversion module 312. In some examples, memory 304 may include temporary memories, meaning that a primary purpose of the one or more storage devices is not long-term storage. Memory 304 may be configured for short-term storage of information as volatile memory and therefore not retain stored contents if deactivated. Examples of volatile memories include random access memories (RAM), dynamic random access memories (DRAM), static random access memories (SRAM), and other forms of volatile memories known in the art. Memory 304, in some examples, also include one or more computer-readable storage media. Memory 304 may be configured to store larger amounts of information than volatile memory. Memory 304 may further be configured for long-term storage of information as non-volatile memory space and retain information after activate/off cycles. Examples of non-volatile memories include magnetic hard disks, optical discs, floppy disks, Flash memories, or forms of electrically programmable memories (EPROM) or electrically erasable and programmable (EEPROM) memories. Memory 304 may store program instructions and/or data associated with one or more of the modules (e.g., accent conversion module 312 of machine learning system 310) described in accordance with one or more aspects of this disclosure.

Processing circuitry 302 and memory 304 may provide an operating environment or platform for accent conversion module 312, which may be implemented as software, but may in some examples include any combination of hardware, firmware, and software. Processing circuitry 302 may execute instructions and memory 304 may store instructions and/or data of one or more modules. The combination of processing circuitry 302 and memory 304 may retrieve, store, and/or execute the instructions and/or data of one or more applications, modules, or software. Processing circuitry 302 and memory 304 may also be operably coupled to one or more other software and/or hardware components, including, but not limited to, one or more of the components illustrated in FIG. 3. Processing circuitry 302 and memory 304 may each be distributed over one or more computing devices.

In accordance with the techniques described herein, machine learning system 310 may train, based on training data 332, accent conversion model 312 to modify speech according to a target accent. In the example of FIG. 3, machine learning system 310 may include training data 332 and accent conversion module 312. Accent conversion model 312 may include decomposition module 314, U-Net model 316, and speech generation module 318. Decomposition module 314 may include a software module with computer-readable instruction for decomposing audio waveforms into short-time magnitudes and short-time phases. U-Net model 316 may include a machine learning model, according to a U-Net architecture, trained based on accented speech clips with aligned phonemes. U-Net model 316 may include a machine learning model trained to map magnitude spectral slices associated with an input audio file to magnitude spectral slices associated with a target accent. Magnitude spectral slices may include, for example, a two-dimensional representation of blocks or bins of spectral magnitudes corresponding to overlapping frames of an audio waveform. U-Net model 316 may include an encoder-decoder structure with skip connections. U-Net model 316 may include an encoder that processes an input spectrogram or other time-frequency representation of an audio signal to extract hierarchical features. U-Net model 316 may include a decoder that synthesizes a modified audio waveform from features of an accent. U-Net model 316 may include skip connections between layers of the encoder and decoder to preserve fine-grained details and facilitate reconstruction of high-quality audio. Speech generation module 318 may obtain a short-time phase from decomposition module 314 and mapped magnitude spectral slices from U-Net model 316 to generate a modified audio waveform according to a target accent.

U-Net model 316 may be trained, based on training data 332, to map segments of magnitude spectral slices associated with input audio to segments of magnitude spectral slices associated with a target accent. During the training of U-Net model 316, decomposition module 314 may decompose synthetic speech clips included in training data 332 into a short-time magnitude and a short-time phase based on, for example, an STFT of the synthetic speech clips. By decomposing an audio waveform to a short-time magnitude, decomposition module 314 converts information from the audio waveform from a time domain in a waveform domain to a frequency domain in a spectral domain.

In some instances, U-Net model 316 may map magnitude spectral slices associated with a source accent that include spectral sequences that are long enough to include phonetic contexts (e.g., phonemes, graphemes, etc.). U-Net model 316 may be trained to map magnitude spectral slices associated with a source accent to magnitude spectral slices associated with a target accent based on an input sliding window with multiple frames covering multiple phonemes from input audio included in input data 334. U-Net model 316 may map magnitude spectral slices associated with a source accent to magnitude spectral slices associated with a target accent by producing a corresponding mapped output spectral sequence with multiple frames covering the multiple phonemes in an output sliding window. U-net model 316 may implement asymmetrical sliding windows with respect to a current time to reduce latency during real-time accent modification of input audio. U-net model 316 may implement input and output sliding windows that partially overlap in time to create a smooth transition across windows. Speech generation module 318 may reconstruct a short-time magnitude to combine with the short-time phase by combining output windows of spectral sequences using an overlap and add method applying a suitable weighting window. In this way, accent conversion module 312 may map magnitude spectral slices associated with a non-native, source accent to magnitude spectral slices associated with a native, target accent at a segment level, rather than at a frame level. By mapping at the segment level, accent conversion module 312 may be able to capture and map more complex phonetic aspects compared to mapping based on a single spectral frame. Decomposition module 314 may decompose a first speech clip associated with a speaker speaking in a first accent and a second speech clip associated with the speaker speaking in a second accent, wherein the first speech clip and the second speech clip are included in an instance of training data included in training data 332. Decomposition module 314 may create a training pair that includes a spectrogram associated with a short-time magnitude of the first speech clip and a spectrogram associated with a short-time magnitude of the second speech clip. Decomposition module 314 may provide the training pair to U-Net model 316, where the spectrogram associated with the short-time magnitude of the first speech clip is labeled as an original audio signal and the spectrogram associated with the short-time magnitude of the second speech clip is labeled as a target audio signal. In this way, decomposition module 314 may provide U-Net model 316 training instances of mappings of spectral representations associated with original audio waveforms to accent shifted spectral representations associated with modified audio waveforms.

U-Net model 316 may be trained based on accented speech clips with aligned phonemes. U-Net model 316 may process the training pair obtained from decomposition module 314 to update parameters of U-Net model 316 based on a loss function. For example, U-Net model 316 may determine a loss function based on differences between a first set of aligned frames associated with a target audio signal (e.g., the spectrogram associated with the short-time magnitude of the second speech clip in the example above) and a second set of aligned frames associated with an audio signal U-Net model 316 generated based on an original audio signal (e.g., the spectrogram associated with the short-time magnitude of the first speech clip in the example above). U-Net model 316 may generate the audio signal based on the original audio by inputting an original spectrogram associated with a short-time magnitude of an original speech clip into a neural network (e.g., a U-Net machine learning model) and outputting a spectrogram converting features of the original spectrogram based on characteristics of an accent associated with the target speech clip included in the training pair with the original speech clip. U-Net model 316 may calculate a loss function based on a comparison of the converted spectrogram and a target spectrogram associated with the target speech clip. U-Net model 316 may update parameters of the neural network (e.g., a U-Net machine learning model) based on the calculated loss function.

Accent conversion model 312, may modify audio waveforms of speech to correspond to a target accent. Accent conversion model 312 may obtain input data 334. Input data 334 may include an audio clip with an audio waveform (e.g., audio 152 of FIG. 1), as well as an indication of an accent to modify the audio clip according to (e.g., a target accent or a requested accent). Accent conversion model 312, or more specifically decomposition module 314, may decompose an audio waveform of input data 334 into a short-time magnitude and a short-time phase. Decomposition module 314 may generate the short-time magnitude and the short-time phase based on a computation of a STFT from the audio waveform of input data 334. Decomposition module 314 may generate segments of magnitude spectral slices based on the short-time magnitude by converting a one-dimensional audio signal of the audio waveform into a two-dimensional representation (e.g., a two dimensional matrix of values). Decomposition module 314 may generate a segment of magnitude spectral slices as a two-dimensional representation of blocks of spectral magnitudes corresponding to overlapping frames of the audio waveform of input data 334. Decomposition module 314 may provide the segments of magnitude spectral slices to U-Net model 316 and provide the short-time phase to speech generation module 318.

Accent conversion model 312, or more specifically U-Net model 316, may map the segments of magnitude spectral slices associated with the short-time magnitude of the audio waveform of input data 334 to magnitude spectral slices associated with a target accent identified in input data 334. For example, U-Net model 316 may be trained to maintain spectrogram characteristics associated with a speaker of the input audio waveform and convert spectrogram characteristics associated with an original accent to spectrogram characteristics associated with the target accent. U-Net model 316 may generate mapped magnitude spectral slices to include spectrogram characteristics associated with the speaker of the input audio waveform and spectrogram characteristics associated with the target accent. For example, U-Net model 316 may generate the mapped magnitude spectral slices by converting the two-dimensional representation of spectral magnitudes corresponding to overlapping frames of the audio waveform of input data 334 to a two-dimensional representation of spectral magnitudes that U-Net model 316 learned based on the aligned training data of training data 332. U-Net model 316 may provide the mapped magnitude spectral slices to speech generation module 318.

Speech generation module 318 may generate modified audio waveforms based on mapped magnitude spectral slices generated by U-Net model 316. For example, speech generation module 318 may generate modified audio waveforms by combining the short-time phase obtained from decomposition module 314 and mapped magnitude spectral slices obtained from U-Net model 316 based on a standard processing techniques such as the Griffin-Lim algorithm. Speech generation module 318 may output the modified audio waveforms to a teleconferencing system, a telephony application, a social media platform, a streaming platform, a streaming service, or other software application for real-time communication. Speech generation module 318 may output the audio file including the modified audio waveforms as output data 338.

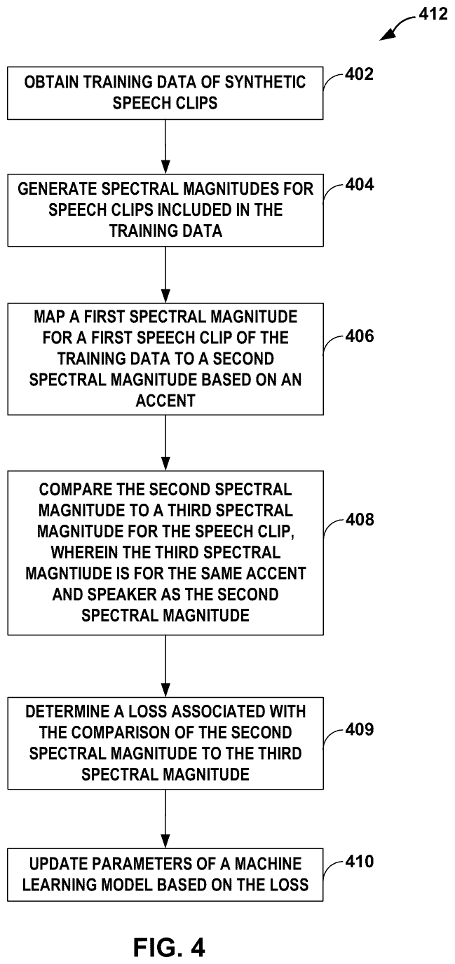

FIG. 4 is flowchart illustrating an example mode of operation for training accent conversion model 412 to modify speech, in accordance with the techniques of the disclosure. Accent conversion model 412 of FIG. 3 may be an example or alternative implementation of accent conversion model 412 of FIG. 2. In the example of FIG. 3, accent conversion model 412 may obtain training data of synthetic speech clips (402). Accent conversion model 412 may obtain training data of synthetic speech clips generated by a TTS model (e.g., TTS model 222 of FIG. 2). Accent conversion model 412 may obtain parallel, phone aligned training data. In some instances, accent conversion model 412 may include training data where an instance of training data includes pairs of differently accented speech clips spoken by the same speaker.

Accent conversion model 412 may generate spectral magnitudes for speech clips included in the training data (404). For example, accent conversion model 412 may compute an STFT from an audio waveform of a synthetic speech clip. Accent conversion model 412 may decompose the calculated STFT of the audio waveform to a short-time magnitude and a short-time phase. Accent conversion model 412 may generate spectral magnitudes for speech clips based on the short-time magnitude of audio waveforms of the speech clip. Accent conversion model 412 may provide the spectral magnitudes to a neural network (e.g., a deep convolutional neural network according to a U-Net architecture) to map spectral magnitudes of the speech clip to spectral magnitudes associated with accent shifted speech. For example, accent conversion model 412 may map a first spectral magnitude for a first speech clip of the training data to a second spectral magnitude based on an accent (406). Accent conversion model 412 may map the first spectral magnitude to the second spectral magnitude by converting spectral characteristics of the first spectral magnitude associated with an original accent of the sample speech clip to spectral characteristics of the second spectral magnitude associated with accent shifted speech.

Accent conversion model 412 may compare the second spectral magnitude to a third spectral magnitude for the speech clip, wherein the third spectral magnitude is for the same accent and speaker as the second spectral magnitude (408). For example, accent conversion model 412 may compare the second spectral magnitude to a spectral magnitude included in the same instance of training data associated with the first spectral magnitude and labeled with the same accent associated with the second spectral magnitude. Accent conversion model 412 may determine a loss associated with the comparison of the second spectral magnitude to the third spectral magnitude (409). For example, accent conversion model 412 may implement a loss function to calculate a loss based on differences of the second spectral magnitude and the third spectral magnitude (e.g., a ground truth spectral magnitude). Accent conversion model 412 may update parameters of a machine learning model based on the loss (410). For example, accent conversion model 412 may adjust model parameters of the neural network used to map spectral magnitudes to minimize the loss.

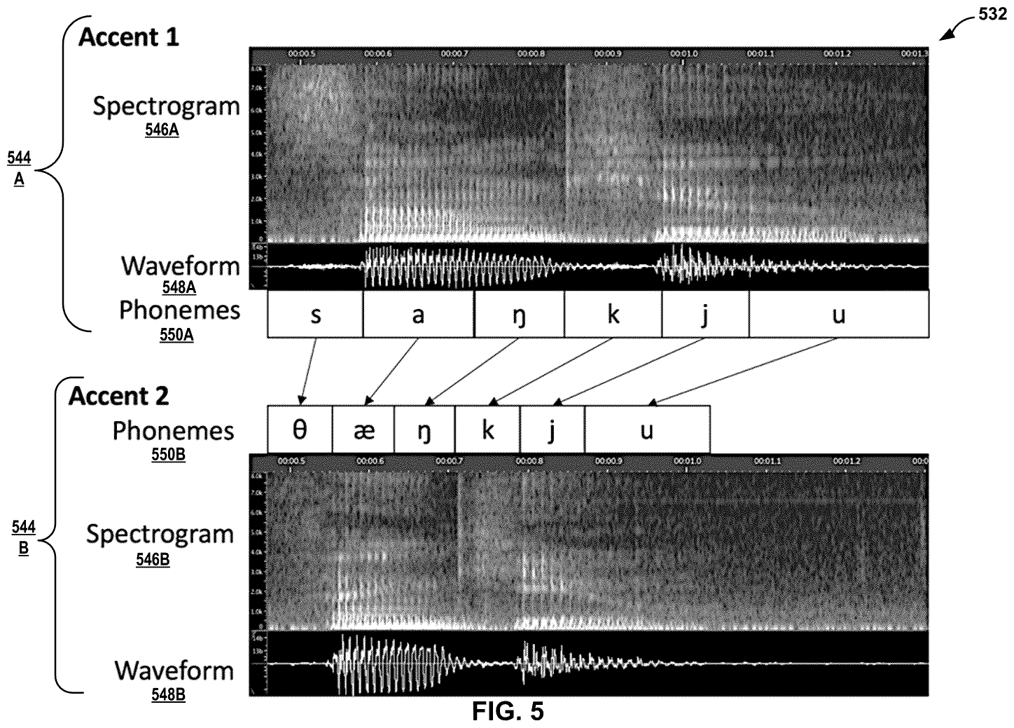

FIG. 5 is a conceptual diagram illustrating alignment of accented speech clips 544 included in training data 532, in accordance with the techniques of the disclosure. Training data 532 in the example of FIG. 5 may be an example or alternative implementation of training data 132 of FIG. 1. FIG. 5 may be discussed with respect to FIGS. 1-3 for example purposes only.

In the example of FIG. 5, training data 532 may include accented speech clip 544A and accented speech clip 544B (collectively referred to herein as, “accented speech clips 544”). Accented speech clips 544 may, for example, be included in an instance of training data generated by training data generation module 124 of FIG. 1. For example, accented speech clip 544B may include a sample speech clip of a speaker saying “thank you” in a source accent, and accented speech clip 544A may include a synthetic speech clip-generated by TTS model 222 of FIG. 2, for example—of the speaker saying “thank you” in a target accent.

Accented speech clips 544 may include spectrograms 546, waveform 548, and phonemes 550. Waveforms 548 may include audio waveforms (e.g., audio waveforms included in audio 152 of FIG. 1) of speech included in sample speech clips 544. Spectrograms 546 may include a spectral magnitude that represents a portion of a magnitude spectral slice (e.g., a block of a spectral magnitude included in a magnitude spectral slice). Spectrograms 546 may represent, in a spectrum domain, a magnitude or amplitude of frequency content and energy distribution associated with waveforms 548. Spectrograms 546 may plot the magnitude of frequency content and energy distribution in a two-dimensional spectral domain with one parameter corresponding to timestamps of frames of accented speech clips 544, and a second parameter corresponding to a frequency of waveforms 548 (e.g., values representing a magnitude of frequencies included in waveforms 548).

In the example of FIG. 5, accented speech clips 544 may include phonemes 550. Phonemes 550 may include a sequence of phonemes corresponding to portions of spectrogram 546 and waveforms 548. Phonemes 550 of accented speech clips 544 may be identified by TTS model 222 of FIG. 2, for example. For example, TTS model 222 may generate a synthetic speech clip of accented speech clip 544A. TTS model 222 may generate accented speech clip 544A to include phonemes 550A based on phonetic contexts TTS model 222 used to generate the synthetic speech clip of accented speech clip 544A. In some instances, TTS model 222 may identify phonemes of a sample speech clip (e.g., a sample speech clip in a source accent). For example, TTS model 222 may create accented speech clip 544B to include phonemes 550B as identified phonemes of a sample speech clip (e.g., the sample speech clip that the synthetic speech clip of accented speech clip 544A was based on). TTS model 222 may provide accented speech clip 544A with the synthetic speech clip and accented speech clip 544B with the sample speech clip to alignment module 226 of FIG. 2, for example.

Alignment module 226, for example, may align phonemes 550 of accented speech clips to be included in an instance of training data 532. For example, alignment module 226 may align accented speech clip 544A and accented speech clip 544B. Alignment module 226 may implement any alignment method (e.g., attention alignments, forced alignments, etc.) to align frames based on phonemes 550, for example. In the example of FIG. 5, alignment module 226 may align accented speech clip 544A with a synthetic speech clip of a speaker speaking the phrase “thank you” in a source with accented speech clip 544B with a sample speech clip of the speaker speaking the phrase “thank you” in a target accent. For example, alignment module 226 may align frames corresponding to the phonetic symbol of “s” in accented speech clip 544A to frames corresponding to the phonetic symbol of “0.” Similarly, alignment module 226 may align frames corresponding to the phonetic symbol of “a” in accented speech clip 544A to frames corresponding to the phonetic symbol of “æ” included in accented speech clip 544B, align frames corresponding to the phonetic symbol of “n” in accented speech clip 544A to frames corresponding to the phonetic symbol of “n” included in accented speech clip 544B, and so on. Training data generation module 224, for example, may generate an instance of training data 532 to include the phoneme-aligned accented speech clips 544.

In some examples, accented speech clip 544A and accented speech clip 544B may include respective synthetic speech clips from a speaker. Accented speech clips 544A and accented speech clip 544B may include synthetic speech clips generated by TTS model 222, for example. TTS model 222 may provide synthetic speech clips associated with accented speech clips 544 to alignment module 226. Alignment module 226 may align a first set of frames associated with the first synthetic speech clip of accented speech clip 544A with a second set of frames associated with the second synthetic speech clip of accented speech clip 544B. For example, alignment module 226 may align frames of accented speech clip 544A and accented speech clip 544B based on phonemes 550, as illustrated in the example of FIG. 5. Training data generation module 224 may generate an instance of training data based on the alignment of the first set of frames associated with the first synthetic speech clip and the second set of frames associated with the second synthetic speech clip.

Accent conversion module 312 of FIG. 3, for example, may train a machine learning model (e.g., U-Net model 316 of FIG. 3) with the phoneme-aligned accented speech clips 544. For example, accent conversion module 312 may learn to map magnitude spectral slices associated with an input audio to magnitude spectral slices associated with accent shifted audio based on the phoneme-aligned accent speech clips 544. Accent conversion module 312 may obtain input data 334 including audio in a source accent associated with accented speech clip 544A and a request to modify the audio according to a target accent associated with accented speech clip 544B. Accent conversion model 312, or more specifically decomposition module 314, may decompose the input audio into a short-time magnitude and a short-time phase (e.g., based on STFT calculations). U-Net model 316 of accent conversion module 312 may be trained, based on the alignment of phonemes 550 included in instances of training data 532, to map magnitude spectral slices associated with the short-time magnitude to magnitude spectral slices associated with the target accent. U-Net model 316 may provide the mapped magnitude spectral slices to speech generation module 318 to combine the short-time phase and the mapped magnitude spectral slices to generate a modified speech clip according to the target accent.

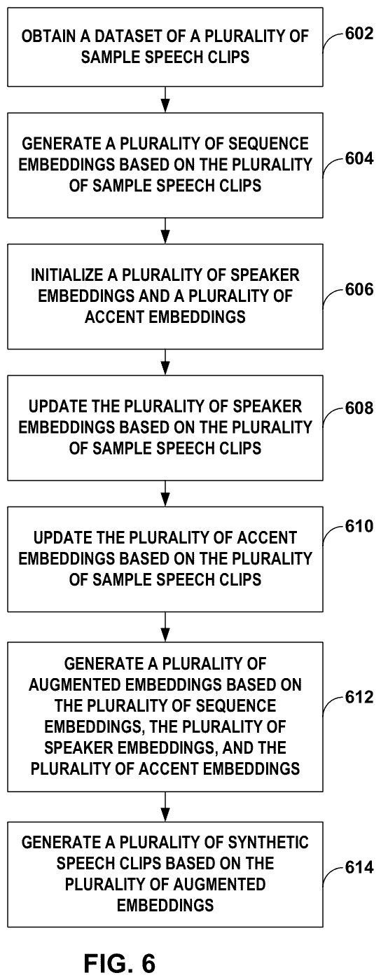

FIG. 6 is a flowchart illustrating an example mode of operation for generating synthetic speech, in accordance with the techniques of this disclosure. FIG. 6 may be discussed with respect to FIG. 1 for example purposes only.

Machine learning system 110 of computing system 100 may obtain a dataset of a plurality of sample speech clips (602). Machine learning system 110 may generate a plurality of sequence embeddings based on the plurality of sample speech clips (604). Machine learning system 110 may initialize a plurality of speaker embeddings and a plurality of accent embeddings (606). Machine learning system 110 may update the plurality of speaker embeddings based on the plurality of sample speech clips (608). Machine learning system 110 may update the plurality of accent embeddings based on the plurality of sample speech clips (610). Machine learning system 110 may generate a plurality of augmented embeddings based on the plurality of sequence embeddings, the plurality of speaker embeddings, and the plurality of accent embeddings (612). Machine learning system 110 may generate a plurality of synthetic speech clips based on the plurality of augmented embeddings (614).

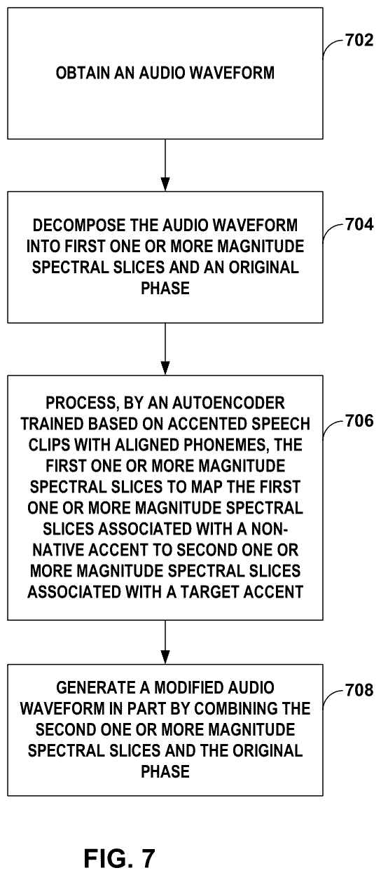

FIG. 7 is a flowchart illustrating an example mode of operation for modifying speech, in accordance with the techniques of this disclosure. FIG. 7 may be discussed with respect to FIG. 1 for example purposes only.

Machine learning system 110 of computing system 100 may obtain an audio waveform (702). Machine learning system 110 may decompose the audio waveform into first one or more magnitude spectral slices and an original phase (704). Machine learning system 110 may process, by an autoencoder trained based on accented speech clips with aligned phonemes, the first one or more magnitude spectral slices to map the first one or more magnitude spectral slices associated with a source accent to second one or more magnitude spectral slices associated with a target accent (706). Machine learning system 110 may generate a modified audio waveform in part by combining the second one or more magnitude spectral slices and the original phase (708).

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in computer-readable media, such as a computer-readable storage medium, containing instructions. Instructions embedded or encoded in one or more computer-readable storage mediums may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

What is claimed is:

1. A method comprising:
obtaining a dataset of a plurality of sample speech clips;
generating a plurality of sequence embeddings based on the plurality of sample speech clips;
initializing a plurality of speaker embeddings and a plurality of accent embeddings;
updating the plurality of speaker embeddings based on the plurality of sample speech clips;
updating the plurality of accent embeddings based on the plurality of sample speech clips;
generating a plurality of augmented embeddings based on the plurality of sequence embeddings, the plurality of speaker embeddings, and the plurality of accent embeddings; and
generating a plurality of synthetic speech clips based on the plurality of augmented embeddings.

2. The method of claim 1, wherein a sample speech clip of the plurality of sample speech clips is labeled with a text transcript and an accent identifier, and wherein updating the plurality of accent embeddings comprises updating an accent embedding of the plurality of accent embeddings based on the text transcript and the accent identifier.

3. The method of claim 1, wherein a sample speech clip of the plurality of sample speech clips is labeled with a text transcript and a speaker identifier, and wherein updating the plurality of speaker embeddings comprises updating a speaker embedding of the plurality of speaker embeddings based on the text transcript and the speaker identifier.

4. The method of claim 1, wherein generating the plurality of augmented embeddings comprises summing the plurality of sequence embeddings with the plurality of speaker embeddings and the plurality of accent embeddings.

5. The method of claim 1, wherein the plurality of synthetic speech clips comprises a first synthetic speech clip associated with a speaker and a first accent and a second synthetic speech clip associated with the speaker and a second accent, and wherein the method further comprises:
aligning a first set of frames associated with the first synthetic speech clip with a second set of frames associated with the second synthetic speech clip; and
generating an instance of training data based on the alignment of the first set of frames associated with the first synthetic speech clip and the second set of frames associated with the second synthetic speech clip.

6. The method of claim 1, further comprising:
providing the plurality of synthetic speech clips to an autoencoder model; and
training the autoencoder model to modify speech of an audio waveform based on the plurality of synthetic speech clips.

7. A computing system comprising processing circuitry and memory for executing a machine learning system, the machine learning system configured to:
obtain a dataset of a plurality of sample speech clips;
generate a plurality of sequence embeddings based on the plurality of sample speech clips;
initialize a plurality of speaker embeddings and a plurality of accent embeddings;
update the plurality of speaker embeddings based on the plurality of sample speech clips;
update the plurality of accent embeddings based on the plurality of sample speech clips;
generate a plurality of augmented embeddings based on the plurality of sequence embeddings, the plurality of speaker embeddings, and the plurality of accent embeddings; and
generate a plurality of synthetic speech clips based on the plurality of augmented embeddings.

8. The computing system of claim 7, wherein a sample speech clip of the plurality of sample speech clips is labeled with a text transcript and an accent identifier, and wherein to update the plurality of accent embeddings, the machine learning system is configured to: update an accent embedding of the plurality of accent embeddings based on the text transcript and the accent identifier.

9. The computing system of claim 7, wherein to generate the plurality of augmented embeddings, the machine learning system is configured to: sum the plurality of sequence embeddings with the plurality of speaker embeddings and the plurality of accent embeddings.

10. The computing system of claim 7, wherein the plurality of synthetic speech clip comprises a first synthetic speech clip associated with a speaker and a first accent and a second synthetic speech clip associated with the speaker and a second accent, and wherein the machine learning system is further configured to:
align a first set of frames associated with the first synthetic speech clip with a second set of frames associated with the second synthetic speech clip; and
generate an instance of training data based on the alignment of the first set of frames associated with the first synthetic speech clip and the second set of frames associated with the second synthetic speech clip.

11. The computing system of claim 7, wherein the machine learning system is further configured to:
provide the plurality of synthetic speech clips to an autoencoder model; and
train the autoencoder model to modify speech of an audio waveform based on the plurality of synthetic speech clips.

12. A method comprising:
obtaining an audio waveform;
decomposing the audio waveform into first one or more magnitude spectral slices and an original phase;
processing, by an autoencoder trained based on accented speech clips with aligned phonemes, the first one or more magnitude spectral slices to map the first one or more magnitude spectral slices associated with a source accent to second one or more magnitude spectral slices associated with a target accent; and
generating a modified audio waveform in part by combining the second one or more magnitude spectral slices and the original phase.

13. The method of claim 12, further comprising:
receiving an indication of the target accent,
wherein processing the first one or more magnitude spectral slices to map the first one or more magnitude spectral slices to the second one or more spectral slices comprises converting, by the autoencoder, based on the indication of the target accent, first spectral characteristics of the first one or more magnitude spectral slices associated with an original accent to second spectral characteristics of the second one or more magnitude spectral slices associated with the target accent.

14. The method of claim 12, wherein training the autoencoder based on accented speech clips with aligned phonemes comprises:
obtaining a dataset of a plurality of sample speech clips;
generating a plurality of sequence embeddings based on the plurality of sample speech clips;
initializing a plurality of speaker embeddings and a plurality of accent embeddings;
updating the plurality of speaker embeddings based on the plurality of sample speech clips;
updating the plurality of accent embeddings based on the plurality of sample speech clips;
generating a plurality of augmented embeddings based on the plurality of sequence embeddings, the plurality of speaker embeddings, and the plurality of accent embeddings;
generating a plurality of synthetic speech clips based on the plurality of augmented embeddings, wherein the plurality of synthetic speech clips comprises a first synthetic speech clip associated with a speaker and a first accent and a second synthetic speech clip associated with the speaker and a second accent;
aligning a first set of frames associated with the first synthetic speech clip with a second set of frames associated with the second synthetic speech clip;
generating an instance of training data based on the alignment of the first set of frames associated with the first synthetic speech clip and the second set of frames associated with the second synthetic speech clip; and
training the autoencoder based on the instance of training data.

15. The method of claim 12, further comprising:
outputting the modified audio waveform.

16. The method of claim 12, wherein the first one or more magnitude spectral slices comprises a two-dimensional representation of blocks of spectral magnitudes corresponding to overlapping frames of the audio waveform.

17. A computing system comprising processing circuitry and memory for executing a machine learning system, the machine learning system configured to:
obtain an audio waveform;
decompose the audio waveform into first one or more magnitude spectral slices and an original phase;
process, by an autoencoder trained based on accented speech clips with aligned phonemes, the first one or more magnitude spectral slices to map the first one or more magnitude spectral slices associated with a source accent to second one or more magnitude spectral slices associated with a target accent; and
generate a modified audio waveform in part by combining the second one or more magnitude spectral slices and the original phase.

18. The computing system of claim 17, wherein to process the first one or more magnitude spectral slices to the second one or more spectral slices, the machine learning system is configured to: convert first spectral characteristics of the first one or more magnitude spectral slices associated with an original accent to second spectral characteristics of the second one or more magnitude spectral slices associated with a target accent.

19. The computing system of claim 17, wherein to train the autoencoder based on accented speech clips with aligned phonemes, the machine learning model is configured to:
obtain a dataset of a plurality of sample speech clips;
generate a plurality of sequence embeddings based on the plurality of sample speech clips;
initialize a plurality of speaker embeddings and a plurality of accent embeddings;
update the plurality of speaker embeddings based on the plurality of sample speech clips;
update the plurality of accent embeddings based on the plurality of sample speech clips;
generate a plurality of augmented embeddings based on the plurality of sequence embeddings, the plurality of speaker embeddings, and the plurality of accent embeddings;
generate a plurality of synthetic speech clips based on the plurality of augmented embeddings, wherein the plurality of synthetic speech clips comprises a first synthetic speech clip associated with a speaker and a first accent and a second synthetic speech clip associated with the speaker and a second accent;
align a first set of frames associated with the first synthetic speech clip with a second set of frames associated with the second synthetic speech clip;
generate an instance of training data based on the alignment of the first set of frames associated with the first synthetic speech clip and the second set of frames associated with the second synthetic speech clip; and
train the autoencoder based on the instance of training data.

20. The computing system of claim 17, wherein the machine learning system is further configured to:
output the modified audio waveform.
